(19) United States
(12) Patent Application Publication
(10) Pub. No.: US 2025/0228341 A1
(43) Pub. Date: Jul. 17, 2025

(54) INFLATABLE TOROIDAL EXHIBITION CANOPY WITH AN ECCENTRIC POLE

(71) Applicant: Marcos ENDO, Sao Paulo (BR)

(72) Inventor: Marcos ENDO, Sao Paulo (BR)

(21) Appl. No.: 18/856,633

(22) PCT Filed: Jun. 3, 2022
(86) PCT No.: PCT/BR2022/050198

§ 371 Date: Oct. 14, 2024

(51) Int. Cl. A45B 19/02; A45B 17/00; G09F 19/00

(52) U.S. Cl. CPC A45B 19/02; G09F 19/008; A45B 2017/005

(57) ABSTRACT

This is an inflatable toroidal display cover with an exocentric rod (CT) comprising a cover (10) formed by an inflatable torus (11) configuring a flat central area (12) and an inflatable torus (11) conified with a larger diameter (d1) rear region (11A) and a smaller diameter (d2) opposite front region (11 B) and that in the rear region (11A) by the inner contour (ct1) includes a pair of upper and lower tether straps (11a1)/(11a2) that anchor profiles (21a)/(21b) of the stabilizer ‘U’ fork (21) with a multi-angle joint (23) integral to the support rod (22) of the cover (10); and support rod (22) in the inner contour (ct1) configuring unobstructed flat central area (12); and rear region (11A) in balance; and tubular niche (11a3) and balanced counterweight (30); and anchorage spaced from the profiles (21a)/(21b) with vertical and horizontal stabilizing staging effect (V1)/(H); and stabilizing U-fork (21) with multi-angle joint (23); and compression points (p1/p2) of easy fastening; and consistent rigid support rod (22); and flat central area (12) and multi-angle joint (23) for printing and easy viewing; and frameable; and, yet, friendly to the touch; flat; compressible; wide view and access.

### TECHNICAL FIELD OF THE INVENTION

The present invention deals with an inflatable toroidal display cover with an exocentric rod with application in the field of sun umbrella, umbrella, tent and temporary shelters.

Said invention also has application in the field of billboard displays and signage.

### BACKGROUND OF THE INVENTION

In open areas, notably on the beach, countryside, swimming pools and parks, it is usually necessary and convenient to provide coverage to people against the sun's rays and possible rain, and the visual exposure of advertisements is also opportune.

The existing sun umbrella and umbrella roofing models currently basically comprise the traditional ones with a concave-shaped area, including the ombrellones, structured by radial rods and supported by a rod punctually connected to the central area of the cover, which have one or more of the following problems and drawbacks: Centralized rod that obstructs the central area of shelter; Rods with tips that cause danger of spiking; Format with concavity that traps the wind causing a greater risk of flying the object and reaching people; Coverage with rods and rigid and fixed parts that restrict their folding and compaction for transport and storage; Central area with obstructions such as rod, poles, buds, crossbars, curvatures and/or concavities that make it difficult to print and view as an advertising panel.

There are also models of the inflatable type, but with concepts close to the traditional ones, whose radial rods and/or central area and/or structures are replaced by inflatable cameras, keeping, however, the centralized rod and the presence of elements in the central area such as buds, crossbars, curvatures and/or concavities, with their respective problems and drawbacks.

There are also models of inflatable tent roofs on the market, including some with the function of an advertising sign, with multiple fixed supports directly on the ground that, among other problems and inconveniences, obstruct the user's field of vision and make it difficult to access them;

In a search carried out in specialized databases, documents such as: WO9107111A1; U.S. Pat. No. 2,827,909; CH352796A were also found with greater relevance.

The document No. WO9107111A1 discloses an umbrella consisting of an inflatable, tubular body with an arched plastic cap and having its rods branched from the annular tube.

The document No. U.S. Pat. No. 2,827,909 discloses an inflatable umbrella with annular edge and which is supported by fixed rod at a point developed from the lower central portion of the inflatable ring.

The document No. CH352796A discloses a sun umbrella or umbrella with inflatable edge of variable diameter, consisting of a disc of plastic film fixed peripherally to a support rod, the peripheral part of which is designed as an annular tube and can be inflated by means of a valve, where it acts as a support ring and which is supported/anchored by inflatable rod fixed at a point originating from the lower portion of the inflatable ring and with transverse reinforcing bars.

However, in the models of the three documents above, one or more of the following problems and drawbacks are observed: Side rod in a position that generates a tipping trend for its front portion; unbalanced cover that accentuates the tipping trend of the cover; Point or circumscribed connection of the rod in the cover that causes a trend of vertical panning and lateral oscillations; Fixed connection between rod and cover that restricts multiple angles of the cover according to the angle of incidence of the sun and rain; Permanent or difficult fixing rod that prevents or hinders its assembly and disassembly; Collapsible inflatable rod by involuntary folding due to pressure loss; Branched rod that invades and partially obstructs the central area of the cover and Format with concavity of the arcuate central area that traps the wind with risk of flight of the object in the specific case of document WO9107111A1; Central area with presence of obstructions such as crossbars, branches, curvatures that make it difficult to print and view as an advertising panel; Rod with fixed connection or direct static support on the ground that does not provide the multi-angulation of the coverage and its central advertising area according to the best angle of view of the audience.

Therefore, it is observed that the state of the art still presents several problems and drawbacks and that there is no antecedent with the characteristics of the present invention presented below, thus evidencing its necessity, utility, novelty and patentability.

### SUMMARY OF INVENTION

Thus, with the purpose of innovating and advancing on the state of the art, the objective of the invention is to present exhibitor coverage that desirably provides in the same object several solutions, advantages and benefits, such as: Central area of unobstructed shelter; Equal; Balanced; Stabilized against panning and oscillations; Multiangle; Easy assembly and disassembly; Consistent support; Ease of printing and viewing; Frameable; And, also, Harmless to skewing; Reduced risk of flight; Foldable and compactable for transport and storage and Wide view and user access.

Thus, “INFLATABLE TOROIDAL DISPLAY COVER WITH EXOCENTRIC ROD” is presented, comprising a cover formed by an inflatable torus configuring a flat central area and an inflatable torus conified with a larger diameter rear region and a smaller diameter opposite front region and that in the rear region by the internal contour includes a pair of upper and lower tie-rod handles that anchor profiles of the stabilizer U-fork with a multiangle joint integral with the support rod of the cover; And a support rod in the internal contour configuring an unobstructed flat central area; And a rear region in balance; And a tubular niche and balancing counterweight; And an anchorage spaced from the profiles with a vertical and horizontal staging effect; And a stabilizer U-fork with a multiangle joint; And easy fixing compression points; And a consistent rigid support rod; And a flat central area and a multiangle joint for easy printing and viewing; And frameable; And, yet, touch-friendly; Planned; Compactable; Wide vision and access.

### DESCRIPTION OF DRAWINGS

To complement the present description in order to obtain a better understanding of the features of the present invention and according to a preferred practical embodiment thereof, the attached description is accompanied by a set of drawings, where, in an exemplary, although not limiting manner, its operation was represented:

FIG. 1A shows a perspective view of the inflatable toroidal display cover with disassembled and compacted exocentric rod for transport and guarding;

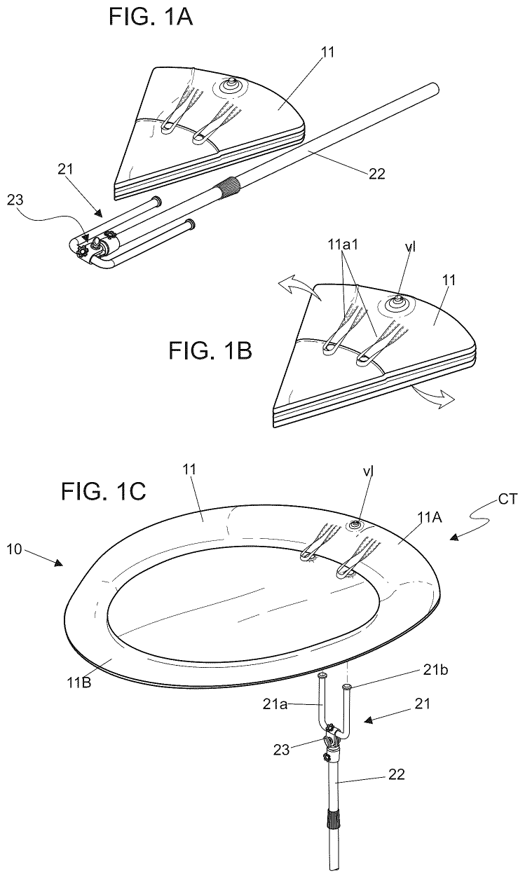

FIG. 1B discloses a perspective view of the deflated cover and being unfolded to start filling;

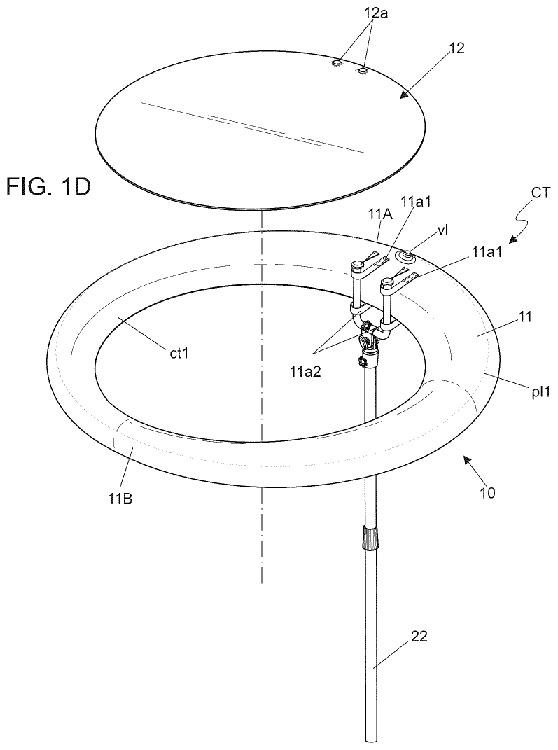

FIG. 1C shows a perspective view of the covering showing the start of filling;

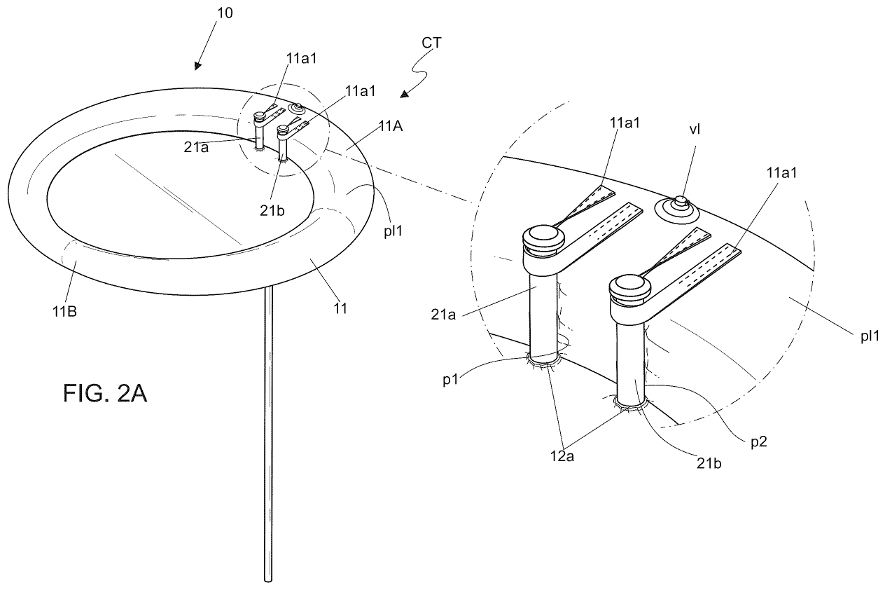

FIG. 1D depicts a perspective view of the exocentric rod inflatable toroidal display cover showing inflated cover and with the multi-angle pivot stabilizer U-fork assembled integral with the support rod in exploded position;

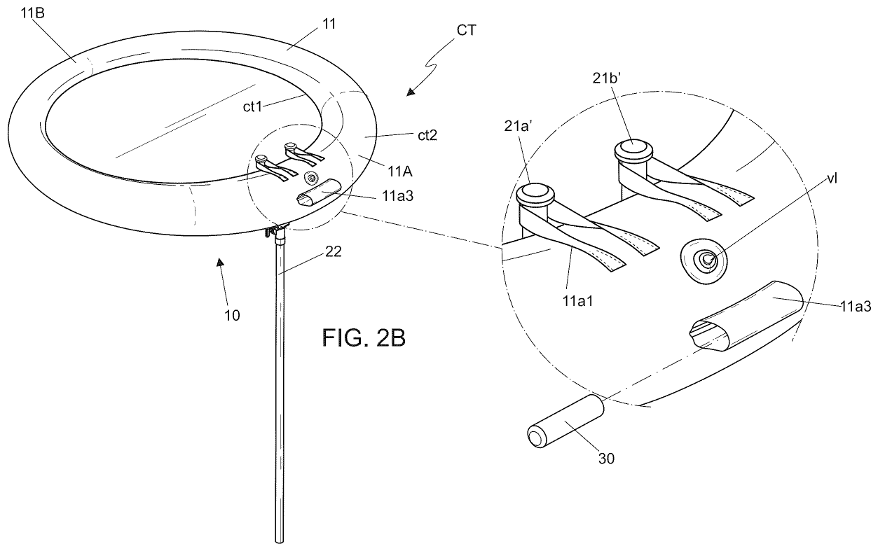

FIGS. 2A and 2B show perspective views of the inflated cover with assembled support rod and respective details of the profiles of the stabilizer U-fork on the tether straps, such as the enlarged counterweight;

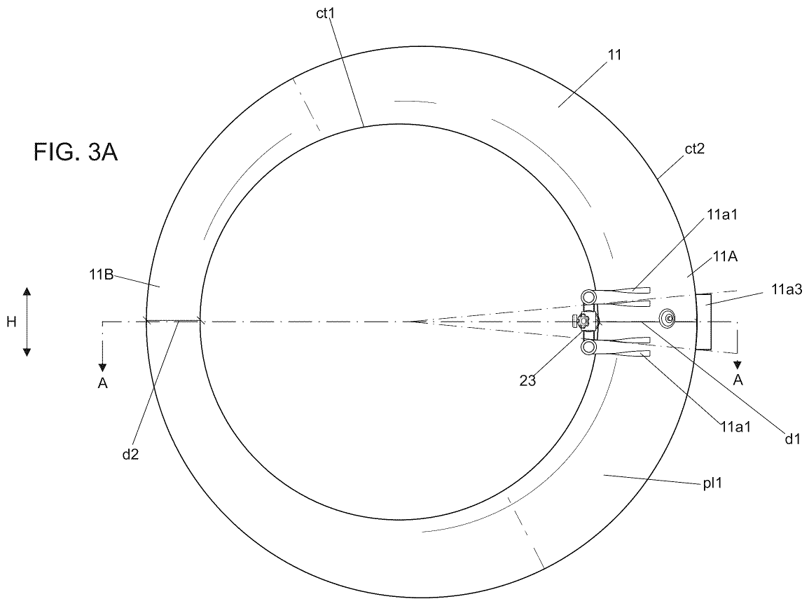

FIG. 3A shows an assembled top view of the rod inflated cover with the assembled multi-angle hinge stabilizer U-fork;

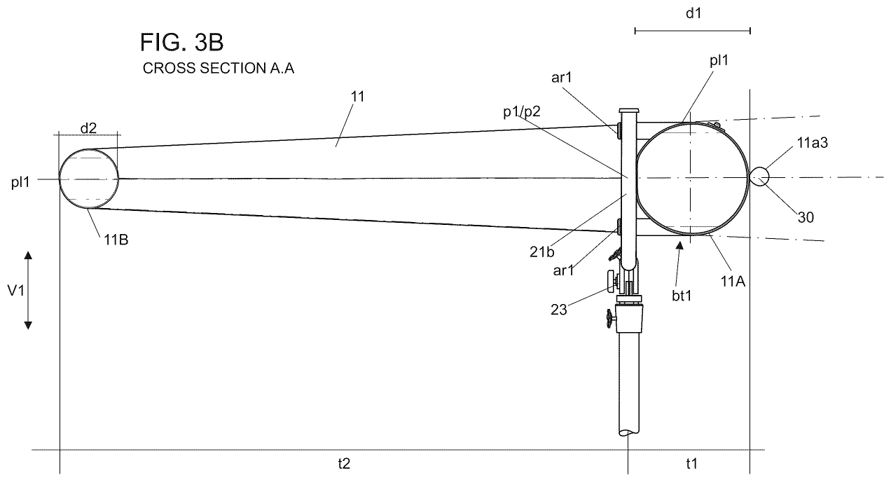

FIG. 3B discloses a longitudinal sectional view A.A indicated in the preceding figure;

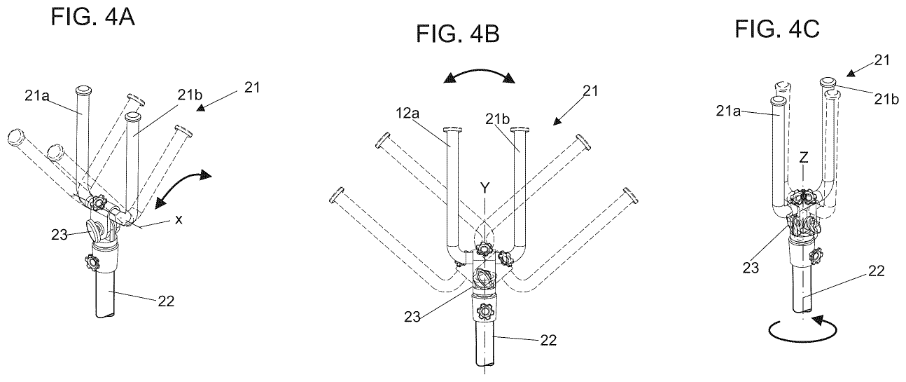

FIGS. 4A, 4B and 4C depict perspective views of the stabilizer U-fork with multi-angle pivot, showing the rotations;

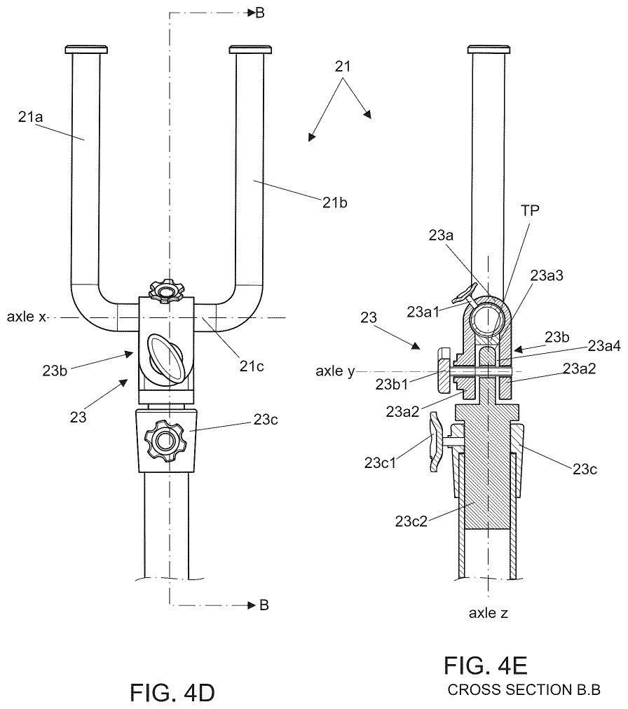

FIGS. 4D and 4E represent front and sectional views B.B of the stabilizer U-fork with multi-angle joint;

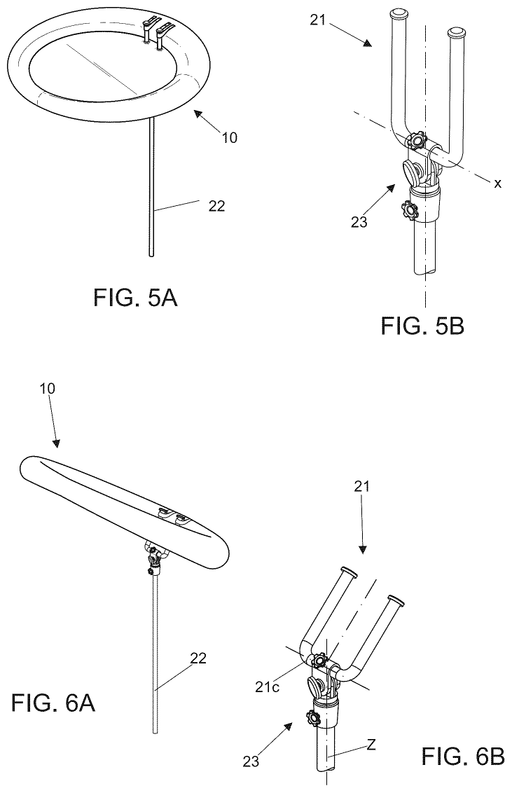

FIGS. 5A and 5B show perspective views of the inflated cover with support rod with assembled multi-angle pivot stabilizer U-fork and positioning of the profiles of the stabilizer U-fork vertically aligned with the support rod;

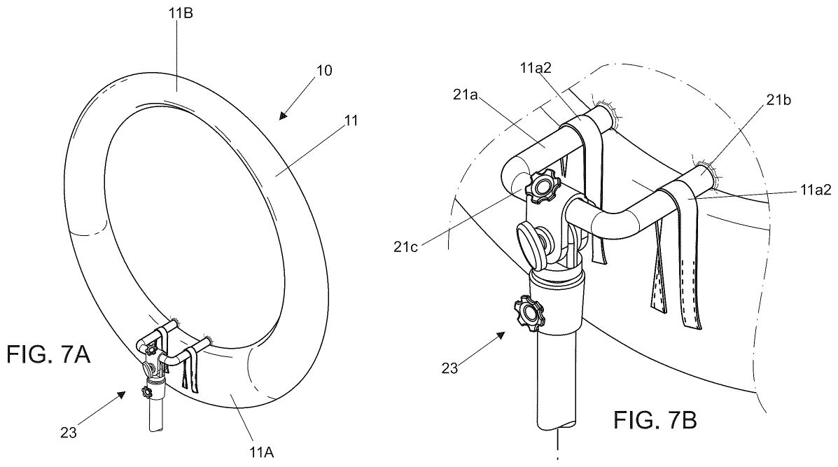

FIGS. 6A and 6B disclose perspective views of the inflatable toroidal display cover with assembled exocentric rod and positioning of the oblique stabilizer U-fork profiles relative to the supporting rod;

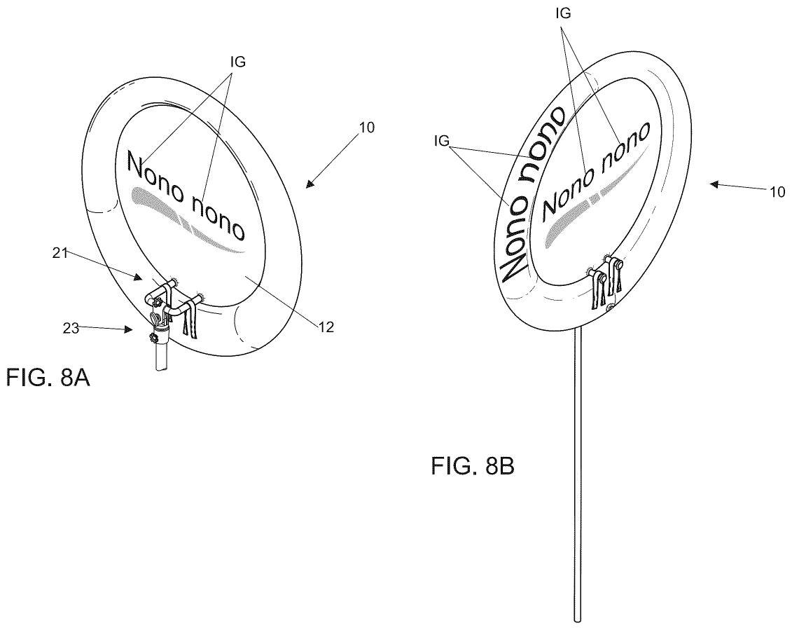

FIGS. 7A and 7B depict perspective views of the inflatable toroidal display cover with assembled exocentric rod, and the highlight of the positioning of the 180° rotated stabilizer U-fork relative to the rod configuring an advertising area perpendicular to the ground;

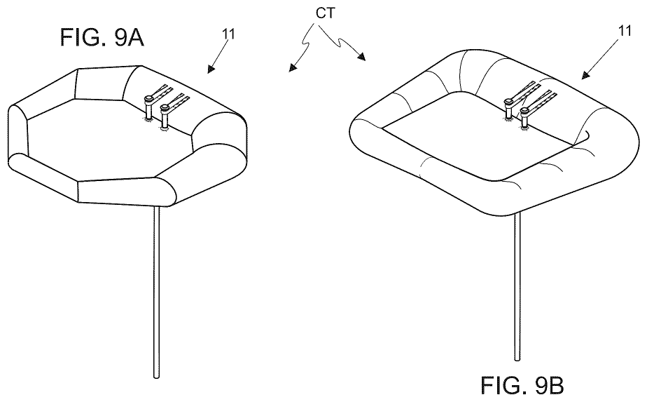

FIGS. 8A and 8B show perspective views of the exocentric rod inflatable toroidal display cover showing the advertising area; and

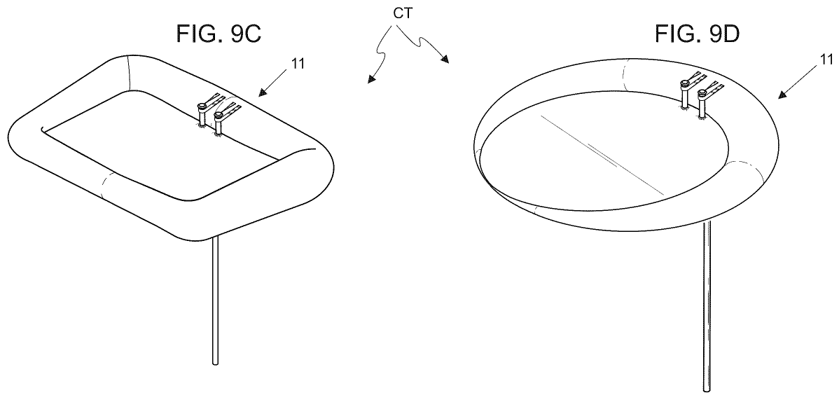

FIGS. 9A, 9B, 9C and 9D disclose perspective views of variations of peripheral figurations of the cover, assembled on the support rod;

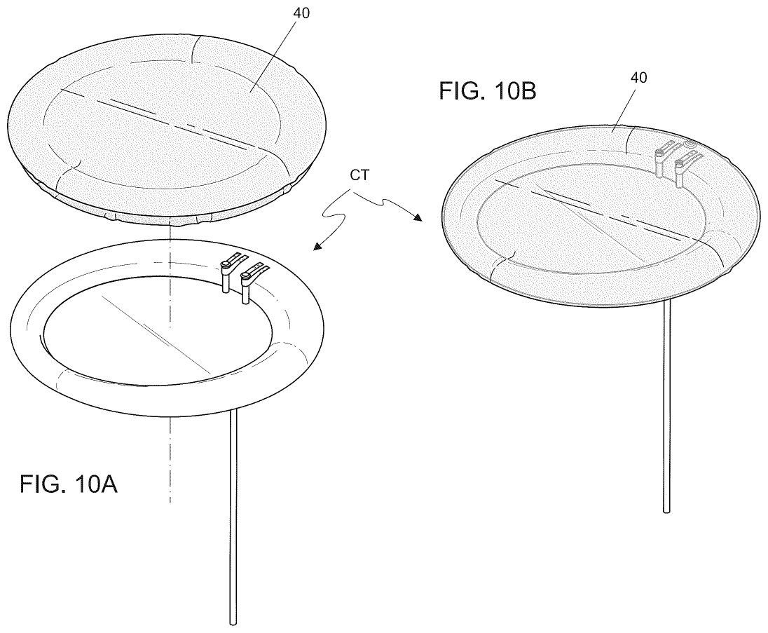

FIGS. 10A and 10B show views of the jacket (optional) separated and dressed on the cover;

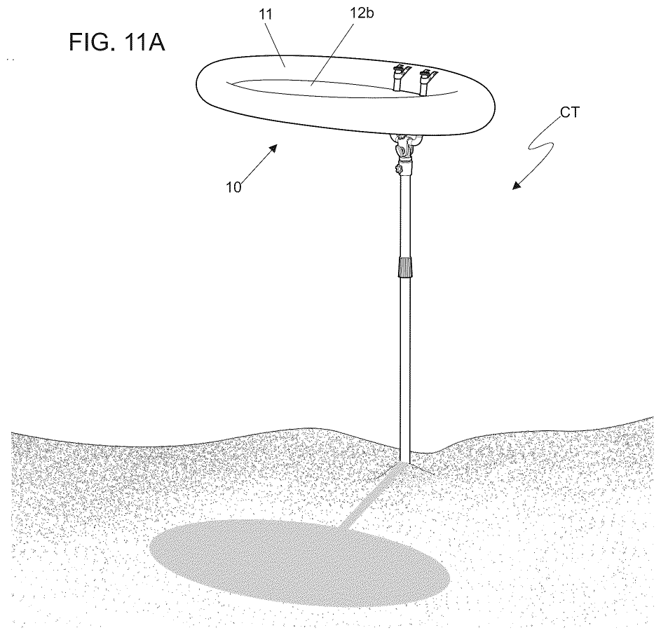

FIGS. 11A and 11B show perspective views of the inflatable toroidal display cover with exocentric rod in normal position with view from the top and bottom of the stabilizer U-fork.

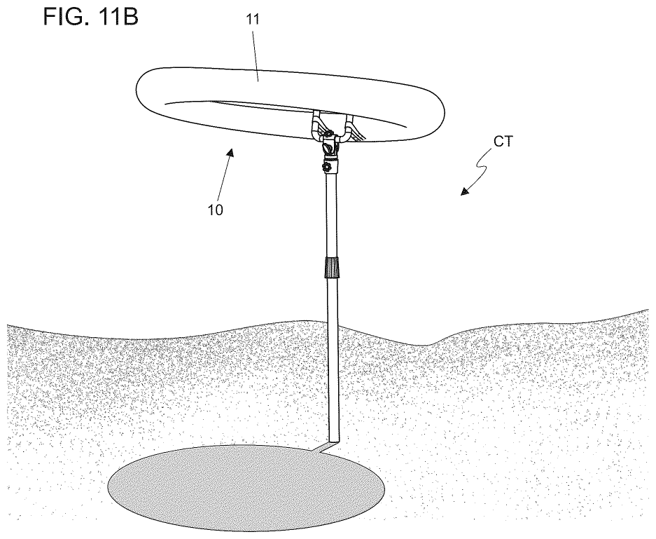

### DESCRIPTION OF THE INVENTION

The present invention patent relates to “INFLATABLE TOROIDAL DISPLAY COVER WITH EXOCENTRIC ROD” (CT) comprising cover (10) formed by inflatable torus (11) inflated through valve (vl) configuring flat central area (12) formed by flexible blanket secured by its edge by the inner contour (ct1) of said inflatable torus (11) and said conified inflatable torus (11) forms gradual variation of diameters (d1)/(d2), comprising rear region (11A) of larger diameter (d1) in relation to the opposite front region (11B) of smaller diameter (d2).

Primordial. And by the present invention, said inflatable torus (11), in said rear region (11A) of greater diameter (d1) and by its internal contour (ct1), includes a pair of upper tether straps (11a1) and a pair of lower tether straps (11a2) that anchor, transversely to the plane of the torus (pl1), the respective protruding profiles (21a)/(21b) of the also included stabilizer U-fork (21) that is endowed with multi-angle joint (23) and that is integral with the supporting rod (22) that supports in position said cover (10).

It should be clarified that the assembly of the anchorage of said profiles (21a)/(21b) begins with the pair of lower tether straps (11a2) passing through watertight passages (12a) present at the edge of said flat central area (12) and then by the pair of upper tether straps (11a1) and is made with the inflatable torus (11) deflated when its free passage is still allowed.

It should be noted that this initial description presents the primordial elements of the invention with a view to its objectives.

Exocentric Rod. And also, by the present invention, said cover (10) presents said support rod (22) positioned in said inner contour (ct1) of the rear region (11A) of said inflatable torus (11) where it anchors, configuring said unobstructed flat central area (12).

It should be noted that this eccentric position of the support rod (22), as described above, unblocks the flat central area (12) and provides the center of shading and free shelter for use with more advantage and efficiency than the antecedents with a detrimental centralized rod and with an unbalanced lateral rod.

Rear region in balance. And also, by the present invention, said inflatable torus (11) presents the rear region (11A) of greater diameter (d1) in balance with respect to the opposite front region (11B) of smaller diameter (d2) in reference to said support rod (22).

It is noted that this balance condition distributes, albeit partially, the weight of the cover (10) between the rear region (11A) and the opposite front region (11B) with reference to the support rod (22).

It should be noted that this distribution of weights reduces the trend of tipping of the assembly to the front portion observed in lateral rod antecedents.

It should also be noted that the reduction of tipping trend is favored by the fact that the rear region (11A) is thicker and contains more air and material in its formation and, consequently, is heavier, exerting greater balancing force.

Counterweight. And also, by the present invention, said inflatable torus (11) in the rear region (11A) of larger diameter (d1) includes, aligned by the outer contour (ct2) opposite the inner contour (ct1), tubular niche (11a3) that accommodates counterweight (30) balancing the weight of the opposite front region (11B) with reference to said supporting rod (22).

It is noted that the balance of the cover (10) on the support rod (22) is obtained by the weight equivalence of the opposite front region (11B) and the counterweight (30).

And that the value of the counterweight (30) equivalent to the weight of the opposite front region (11B) is calculated by the ratio of its forces by the universal formula of the lever taking into account the distance (t1) between the support rod (22) and the rear region (11A) that includes the tubular niche (11a3) and the distance (t2) between the support rod (22) and the opposite front region (11B).

And that the counterweight (30) has an accommodating bar shape in the tubular niche (11a3) and consists of high-density material, traditionally used as ballast, such as metals, plastics, rubbers, stones and concrete, preferably rubber, as in the presented embodiment.

It should be noted that the cover balance (10) as described above provides the neutralization of the trend of tipping cover for its front portion observed in decentralized rod antecedents.

Staging tether straps. And also, by the present invention, said inflatable torus (11) includes a pair of upper tether straps (11a1) and a pair of lower tether straps (11a2) that associated by the spaced anchorage with the respective profiles (21a)/(21b) projecting from said stabilizer U-fork (21) configure the vertical (V1) and horizontal (H) staging effect of said cover (10).

Note that the pair of upper tether straps (11a1) and pair of lower tether straps (11a2) are connected by the ends of the strap tethers respectively in the region of the top of the torus (pl1) and in the region of the base of the torus (bt1) in the rear region (11A) of larger diameter (d1).

And that said pairs of tether straps (11a1)/(11a2) are positioned in the projection of said profiles (21a)/(21b) of the stabilizer U-fork (21).

And that said profiles (21a)/(21b) of the stabilizer U-fork (21) present the length equal to the diameter of the inflatable torus in its rear region (11A) of greater diameter (d1) plus the handling space of said multi-angle joint (23) and present the spacing between them equal to the minimum amplitude of 5°, sufficient for interleaving the multi-angle joint (23), and extreme maximum of 60° projected in the internal contour (ct1) in said rear region (11A) of greater diameter (d1) considering a circumference with a center coincident with the center of the flat central area (12), being preferred the moderate amplitude of 10° approximately in the presented embodiment.

And that a handle of the pair of lower tether straps (11a2) and a handle of the handles of the pair of upper tether straps (11a1) are anchored in each of the profiles (21a)/(21b) projecting from the stabilizer U-fork (21) configuring 4 anchoring locations (ar1) spaced apart from each other vertically by the length of the profiles (21a)/(21b) and horizontally by the distance between said profiles.

And thus, note that the rocking effect of the cover (10) is obtained by the distance and consequent greater angulation action of the anchoring sites (ar1) in relation to the movement axes, notably the vertical (V1) and the horizontal (H) in relation to the support rod (22).

It should be noted that the staging effect holds the vertical (v1) and horizontal (H) movement, stabilizing the cover, respectively, against the vertical panning and the horizontal oscillation frequently observed in lateral rod antecedents.

Multi-angle ‘U’-fork. And also, by the present invention, said support rod (22) includes stabilizer U-fork (21) endowed, directly at the base of the U (21c), with multi-angle joint (23) that angles the cover vertically in tilting on the X-axis; laterally in inclination on the Y-axis and horizontally in rotation on the Z-axis.

It should be noted that the stabilizing U-fork (21) in addition to the association with the pairs of upper and lower tether straps (11a1)/(11a2) for configuring the vertical staging effect (V1) and horizontal staging (H) is provided directly at the base of the U (21c) with a multi-angle joint (23) for multi-angulation.

And that the multi-angle joint (23) composed of X-axis bearing (23a) with X-axis adjustment handle (23a1) being X-axis constituted by the very profile of the U-base (21c) of the stabilizer U-fork (21) that angles the cover (10) vertically in 0° to 180° approximately tilting; composed of Y-axis junction (23b) with Y-axis adjustment handle (23b1) being Y-axis constituted by the very screw of the Y-axis adjustment handle (23b1) that angles the cover (10) laterally in 0° to 180° approximately inclination and composed of Z-axis sleeve (23c) integral with the supporting rod (22) with Z-axis adjustment Handle (23c1) being Z-axis constituted by fitting pin (23c2) that angles the cover (10) horizontally in 360° rotation.

It should also be noted that the X-axis bearing has the substantially round profile from which the tabs (23a2) of the Y-axis junction (23b) exit parallel on one side and on the other of its wall, in tangential continuation, interspersed by the Y-axis disc (23a3) from which the fitting pin (23c2) of the Z-axis exits in expanded continuation.

It should also be noted that the X-axis bearing (23a) has an opening (23a4) between said tabs (23a2), above the Y-axis disc (23a3), for forced fitting of the X-axis with buffering (TP) prediction.

And that the adjustment handles of the X and Z axes are of the screw type and arranged transversely to their respective axes so as to, by the action of their insertion ends, compress and release them and thus lock and unlock them at the desired angles of these X and Z axes.

And that the Y-axis adjustment handle (23b1) is of the threading axis type arranged axially to its Y-axis so as to act by compressing and releasing from the tabs (23a2) against the Y-axis disc (23a3) of the Y-axis junction (23b) to thereby lock and unlock it at the desired angle of this Y-axis.

And that said multi-angle joint (23) has its body made of plastic or metallic material, conformed by traditional applicable processes, preferably being made of plastic, as in the presented embodiment.

It should also be noted that said multi-angle joint (23) takes advantage of the very profile of the base of the U (21c) of the stabilizer U-fork (21) to compose the X axis and concentrates the 3 axes of angles and their adjustments close to their anchorage location between the cover (10) and the support rod (22).

It should be noted that the multi-angulation of the inflatable cover as presented above provides various possibilities of angulation of the cover, in a concentrated way, in the three X Y Z axes according to the incidence of the sun and rain, which is not foreseen in other antecedents.

Fastener compression points. And also, by the present invention, said protruding profiles (21a)/(21b) of said stabilizing U-fork (21) anchored in the respective pair of upper tether straps (11a1) and pair of lower tether straps (11a2) present compression points (p1) (p2) for fixing the anchorage mechanically configured by the conformation and expansion of said inflatable torus (11) by its filling.

It should be clarified that the assembly and disassembly of the stabilizing U-fork (21) in the respective pairs of upper tether straps (11a1) and pair of lower tether straps (11a2) is made with the inflatable torus (11) deflated when the compression points (p1)/(p2) have not yet been configured, allowing the profiles (21a)/(21b) to pass freely.

It should be noted that this form of fastening provides ease of assembly and disassembly without the need for tools.

Rigid material support rod. And also, by the present invention, said support rod (22) is made of substantially rigid material selected from metals, woods, composites and hard plastics.

It should be noted that the support rod (22) is of the elongated profile type conformed by traditional processes applicable to the chosen material.

It should be clarified that among the selectable materials is preferably metal and more preferably aluminum, as in the presented embodiment.

It should be noted that the rigidity of the material of constitution of the support rod (22) gives consistency to the support and avoids the risk of collapse by involuntary folding observed in inflatable rod antecedents.

Exhibitor with flat and multi-angle area. And also, by the present invention, as an exhibitor, said cover (10) presents a flat central area (12) capable of receiving various graphic inscriptions (IG) supported by said support rod (22) with said stabilizer U-fork (21) equipped with a multi-angle joint (23) for adjusting its angle of visibility, vertically in tilting; laterally in inclination and horizontally in rotation.

It should be noted that the flat central area (12) facilitates the printing of various graphic inscriptions (GI), made difficult in antecedents with an obstructed central area.

It should be noted that the support rod (22) provides a prominent elevated position for the exposure and the multi-angle joint (23) allows the exposure to be adjusted according to the best viewing angle of the audience present, up to the perpendicular to the ground.

It should be clarified that at extreme angles such as in the position perpendicular to the ground, the balance and the counterweight are inoperative, but the center of gravity of the cover is kept balanced close to the support rod (22).

It should be clarified that the inflatable torus (11) can also receive miscellaneous graphic inscriptions (GI).

Framing. And also, by the present invention that said inflatable torus (11) has a frameable toroidal shape, in peripheral figuration, among those substantially circular, oval, quadrangular, rectangular, hexagonal and other surrounding toroidal conified with a rear region (11A) of larger diameter (d1) and opposite front region (11B) of smaller diameter (d2).

It should be clarified that among the selectable figurations, with the same functionality, the substantially circular in the embodiment presented was selected in framing.

It should be noted, on the other hand, the possibility, in an ornamental character, of framing the selection of peripheral figuration to the message of the various graphic inscriptions (IG).

Inflatable Torus Materials. It should be noted that said cover (10) is made of malleable, waterproof and inflatable material of the canvas type, polyvinyl film and water-and air-tight fabrics, conformed by traditional applicable processes, preferably being made of polyvinyl film, as in the presented embodiment.

It is clarified that said flat central area (12) and pairs of tether straps (11a1)/(11a2) do not necessarily need to be of airtight inflatable material. And that the above materials normally admit solar filtration treatment, notably UV.

It should be noted that these types of materials are soft and touch-friendly, offering no danger of spiking by rod tips present in traditional antecedent models.

Planned coverage. It is informed that said cover (10) has a flat central area (12) and does not exhibit concavities.

It should be noted that the flattened shape of the cover allows the wind to pass through the set more easily without its entrapment without risk of flying and hitting people, as occurs in the concave formats of traditional sun umbrellas.

Bendable. It is informed that said cover (10) is deflatable, disconnectable from the support rod (22) and foldable because it does not contain rods and rigid parts.

It should be noted that, thus, the coverage provides wide folding and compaction to facilitate transport and storage.

Soil support. It should be noted that in the use of the cover, the support rod (22) is normally anchored to the ground by traditional means, such as pedestals, tripods, supports and crimping in the substrate.

It should be clarified that the user normally shelters below the cover in the flat central region (12b) and according to the angle of incidence of the sun and rain.

It should be clarified that in case of accumulation of water on top of the flat central region (12b) its drainage can be made by the opposite front region (11B) of smaller diameter (d2) tilting the cover (10) downwards in this direction.

It should also be noted that because it is unique, the support rod (22) provides a wide field of view and access.

Folding. It is informed that said profiles (21a)/(21b) of said stabilizer U-fork (21) are foldable to align with the support rod (22) therebetween facilitating safer transport and storage.

Support rod with partition. It should be noted that said support rod (22) provides a partition that allows the reduction of its length by telescopic system or undocking for the purpose of facilitating transport and storage.

Tubular and solid. It is informed that said stabilizer U-fork (21), including its profiles (21a)/(21b), is made of substantially rigid material including metals and plastics, shaped by traditional applicable processes, being preferably metal and more preferably aluminum, as in the presented embodiment.

It is informed that said stabilizer U-fork (21), including its profiles (21a)/(21b), is made of substantially round profile, including those tubular and solid, being preferably tubular, as in the presented embodiment.

Substantially straight profiles. It is informed that the profiles (21a)/(21b) of the stabilizer U-fork (21) are substantially straight.

Proportion. It should be noted that said inflatable torus (11) can be scaled to the desired size and presents the proportion between the perimeter of its external contour (ct2) and the perimeter of its internal contour (ct1) between 95% and 55%, being preferred the moderate percentage of 72% approximately in the presented embodiment.

Conification. It should be informed that said inflatable torus (10) presents conification that forms a gradual variation of diameters (d1)/(d2) comprising a rear region (11A) of greater diameter (d1) in relation to the opposite front region (11B) of smaller diameter (d2) in the proportion of 0% to 95% of the smaller in relation to the larger, being preferred the moderate proportion of 50% approximately in the presented embodiment.

It should be clarified that in the proportion reduced to 0%, it presents an anomalous toroidal figure, but still capable of forming the cover and configuring the flat central area (12).

Beacon finishes. It should be noted that said profiles (21a)/(21b) of the stabilizer U-fork (21) provide at their ends beacon finishes (21a′)/(21b′) of the upper limits of the anchorage of the pair of upper tether straps (11a1).

Detachable central area. It is informed that said flat central area (12) is secured in the inner contour (ct1) of said inflatable torus (11) by traditional permanent fastening means such as integrated, glued and welded or detachable such as brackets, straps and hooks, being preferably welded, as in the presented embodiment.

Accessory cover. It should be noted that said flat central area (12) provides an overcoat (40) of complementary protection capable of receiving graphic inscriptions (GI) formed by a flexible wrapping blanket with elastic edge dressed over the inflatable torus (11).

It is certain that when the present invention is put into practice, modifications may be introduced with regard to certain details of construction and form, without this implying departing from the fundamental principles that are clearly substantiated in the set of claims, thus being understood that the embodiments and terminology of this description are not limiting.

1) “INFLATABLE TOROIDAL DISPLAY COVER WITH EXOCENTRIC ROD”, (CT) comprising cover (10) formed by inflatable torus (11) inflated through valve (vl) configuring flat central area (12) formed by flexible blanket secured by its edge by the inner contour (ct1) of said inflatable torus (11) and said inflatable torus (11) conified in a gradual variation of diameters (d1)/(d2), comprising a rear region (11A) of greater diameter (d1) in relation to the opposite front region (11B) of smaller diameter (d2); characterized in that said inflatable torus (11), in said rear region (11A) of greater diameter (d1) and by its inner contour (ct1), including a pair of upper tether straps (11a1) and a pair of lower tether straps (11a2) that anchor, transversely to the plane of the torus (pl1), the respective profiles (21a)/(21b) projecting from the also included stabilizer fork (21) that is endowed with multi-angulable joint (23) and that is integral to the support rod (22) that supports in position said cover (10).

2) “INFLATABLE TOROIDAL DISPLAY COVER WITH EXOCENTRIC ROD”, according to claim 1, characterized in that said cover (10) presents said support rod (22) positioned in said inner contour (ct1) of the rear region (11A) of said inflatable torus (11) where it anchors, configuring said unobstructed flat central area (12).

3) “INFLATABLE TOROIDAL DISPLAY COVER WITH EXOCENTRIC ROD” according to claim 1, characterized in that said inflatable torus (11) presents the rear region (11A) of larger diameter (d1) in balance with respect to the opposite front region (11b) of smaller diameter (d2) in reference to said supporting rod (22).

4) “INFLATABLE TOROIDAL DISPLAY COVER WITH EXOCENTRIC ROD” according to claim 1, characterized in that said inflatable torus (11) in the rear region (11A) of larger diameter (d1) includes, aligned by the outer contour (ct2) opposite the inner contour (ct1), tubular niche (11a3) that accommodates counterweight (30) balancing the weight of the opposite front region (11B) with reference to said supporting rod (22).

5) “INFLATABLE TOROIDAL DISPLAY COVER WITH EXOCENTRIC ROD”, according to claim 1, characterized in that said inflatable torus (11) includes a pair of upper tether straps (11a1) and a pair of lower tether straps (11a2) that associated by the spaced anchorage with the respective profiles (21a)/(21b) projecting from said stabilizer U-fork (21) configure the vertical (V1) and horizontal (H) staging effect of said cover (10).

6) “INFLATABLE TOROIDAL DISPLAY COVER WITH EXOCENTRIC ROD”, according to claim 1, characterized in that said support rod (22) includes stabilizer U-fork (21) equipped, directly at the base of the U (21c), with multi-angle joint (23) that angles the cover vertically in tilting on the X axis; laterally in inclination on the Y axis and horizontally in rotation on the Z axis.

7) “INFLATABLE TOROIDAL DISPLAY COVER WITH EXOCENTRIC ROD”, according to claim 1, characterized in that said profiles (21a)/(21b) projecting from said stabilizer U-fork (21) anchored in the respective pair of upper tether straps (11a1) and pair of lower tether straps (11a2) present compression points (p1) (p2) for fixing the anchorage mechanically configured by the conformation and expansion of said inflatable torus (11) by its filling.

8) “INFLATABLE TOROIDAL DISPLAY COVER WITH EXOCENTRIC ROD” according to claim 1, characterized in that said supporting rod (22) is made of substantially rigid material selected from metals, woods, composites and hard plastics.

9) “INFLATABLE TOROIDAL DISPLAY COVER WITH EXOCENTRIC ROD”, according to claim 1, with application as an advertising plate, characterized in that said cover (10) presents a flat central area (12) capable of receiving various graphic inscriptions (IG) supported by said support rod (22) with said stabilizer U-fork (21) equipped with a multi-angle joint (23) for adjusting its angle of visibility, vertically in tilting; laterally in inclination and horizontally in rotation.

10) “INFLATABLE TOROIDAL DISPLAY COVER WITH EXOCENTRIC ROD”, according to claim 1, characterized in that said inflatable torus (11) presents a frameable toroidal shape, in peripheral figuration, among those substantially circular, oval, square, rectangular, hexagonal and other surrounding toroidal conified with a rear region (11A) of larger diameter (d1) and opposite front region (11B) of smaller diameter (d2).
